(19) United States
(12) Patent Application Publication
(10) Pub. No.: US 2012/0040729 A1
(43) Pub. Date: Feb. 16, 2012

(54) METHOD AND APPARATUS FOR PLAYING A WAGERING CARD GAME

(76) Inventor: Raphael Mourad, Ontario (CA)

(21) Appl. No.: 13/183,039

(22) Filed: Jul. 14, 2011

Related U.S. Application Data
(63) Continuation-in-part of application No. 11/868,759, filed on Oct. 8, 2007, now abandoned.

(51) Int. Cl. G06F 17/00; A63F 1/00

(52) U.S. Cl. 463/12; 273/292

(57) ABSTRACT

The present application discloses methods of playing card games using a standard 52 card deck involving a dealer and one or more players as well as apparatus for simulating these card games. The games are modifications of blackjack employing features of baccarat to overcome deficiencies of both these games.

### RELATED APPLICATIONS

This application is a continuation-in-part of U.S. patent application Ser. No. 11/868,759 filed Oct. 8, 2007.

### FIELD OF THE INVENTION

This invention relates to methods for playing card games and more particularly to novel forms of card games based on blackjack and baccarat.

### BACKGROUND OF THE INVENTION

Blackjack, also known as “21”, is the most popular and largest revenue generating casino table game in North America, due to its simple and easy to learn rules. For example, blackjack accounts for casino winnings of approximately one half of all table games and it is second only to slot machines in overall casino revenue in Nevada, USA. There are about twice as many blackjack tables as all other table games combined in Nevada.

In blackjack, when played as a casino card game, there is a dealer and at least one player. Each player makes an initial wager against the gaming house usually subject to certain specified betting limits. Each player is dealt two cards face up and the dealer receives a face up card and a face down card. Each spot card has a value equal to the number of the corresponding spot card and each of the jacks, queens and kings has a value of ten. The ace can also have a value of 11. The total count of a hand is equal to the sum of the cards in the hand. Each player is given the opportunity by the dealer to draw further cards but, if the player exceeds the total count of 21, the player loses and forfeits the wager. A player will win if his total count exceeds that of the dealer, and push if his total count equals the dealer's total count.

Blackjack however has some drawbacks. There are some well known tactics that experienced blackjack players follow and when an inexperienced player at the same table as an experienced player does not follow these tactics and draws a card that would have otherwise caused the dealer to “bust”, and thus causes the dealer not to bust, experienced players get frustrated.
“It's never easy to ignore the player that hits on 14 when the dealer has an upcard of 4. It's especially not easy when the dealer goes on to hit 21 and bust everyone out of the hand! In fact, you'd almost have to place all of the blame on the bad player that hit on 14 despite every piece of blackjack strategy suggesting not to. Most experienced players will leave the table while grumbling curse words if something like this happens.”
   http://www.777.com/articles/do-bad-blackjack-players-really-affect-you Although there may be no statistical basis for this perception, this is a very widely held belief.

When a player leaves a blackjack table in frustration, there is nothing preventing that player from going to anther casino, or stopping for the day. Since the odds of blackjack are in the casino's favor, the casino will always win in the long run, thus the longer a player stays at a blackjack table the more money the casino should make.

Another well-known card game played in casinos is Baccarat, a type of card game, which has several variations. Baccarat is the most popular and largest revenue generating casino table game in Asia. For example, in the gambling center of Macau, Baccarat accounts for casino winnings of approximately one half of the winnings from all table games and slot machines in casino revenue. In Macau, there are about four times as many Baccarat tables as all other table games combined, including blackjack tables. In a traditional Baccarat card game, two cards are first dealt to a player's hand and two cards are dealt to a banker's hand. An additional card may be dealt depending on the total numerical value of two cards of the “player” and “banker” respectively. Each player wagers a desired amount of money on either the banker and/or the player hand in designated betting areas in order to start a round of the game. In Baccarat, the objective is to obtain a hand closest to nine. An ace has a value of 1 in Baccarat and cards 2 through 9 have point values equal to their face values. Tens, jacks, queens and kings have a point value of zero in this game. A total count of any Baccarat hand is the sum of the value of the cards in the hand except that a sum of two digits has a total count equal to the last digit.

The problem with baccarat is that an additional third card is drawn the “player” and/or “banker” hands according to a complex hard to learn set of rules, that the player has no control over.

The present invention corrects the above problems of blackjack and baccarat by not allowing the dealer to draw additional cards, and letting the player decide when to draw additional cards for their hand.

### SUMMARY OF THE INVENTION

The method of playing a card game according to the present invention combines and improves upon the features of conventional blackjack. The present invention does this by using the baccarat counting system, thereby not allowing the dealer to draw additional cards beyond the two cards initially dealt, and allowing each player to draw additional cards only by increasing their bets. Thus the present invention can be attractive to players of blackjack. The present invention can also be attractive to players of baccarat since they have control over their hand and wagers. The present invention can also be attractive to casual gamblers who are looking for entertainment but do not wish to commit to a high level of concentration and mental activity in order to play the game. As in the game of blackjack, each player is able to compete against the dealer and the game is relatively simple to play.

According to one embodiment of the invention, a method of playing a card game involving a dealer and at least one player includes the steps of having each player make an initial wager against a gaming house conducting the card game and the dealer dealing first and second cards to each player and to the dealer. Each deck comprises four suites of cards, including spot cards from ace to 10, jacks, queens and kings. Each of the spot cards from ace to 9 has a value equal to the number of the corresponding spot card with ace being 1 and each of the tens, jacks, queens and kings has a value of zero. A total count for any hand in the game is the last digit of the sum of the value of the cards in the hand. The dealer may not draw additional cards beyond those originally dealt but player is allowed a first option to stand with the initial two card hand and second option to draw a third card by increasing the wager by a predetermined value, the values of which is added to the value of the initial hand to determine the total count of the player's hand. In the event that any player selects the second option, that player must double his initial wager before receiving the third card. Then, the total count of the dealer's two card hand is compared with the total count of each player's hand. Any player's hand having a total count at least two points higher than the total count of the dealer's hand results in a push or win for the respective player and any player's hand having a total count which does not exceed the total count of the dealer's hand by more than one point is a loss for the respective player. A payment is made to each winning player according to a predetermined payout schedule.

In a preferred version of this card game, each player is offered the option, after the first and second cards are dealt to each player and to the dealer, to surrender a portion of his initial wager and then to receive back a remaining portion of his initial wager and withdraw from further play of the hand. For example a player could surrender if the total count was 0, or 1 and they did not wish to draw another card. Since in this version of the game the player has to win by 2 or more points it would be impossible to win with a hand of 0 or 1.

In a preferred version of this card game, each player is provided with the option of being dealt a fourth card by increasing the wager by a predetermined amount, the value of which is added to the value the three cards previously dealt to determine the total count of the player's hand before this total count is compared to the total count of the dealer's hand. The player is required to increase the wager to exercise this option, thus making the player rethink whether or not they should draw a card.

In a preferred version of this card game, if the dealer is showing an 8 or 9 on top, the dealer offers each player the option to “buy insurance” whereby a predetermined wager is placed down. If the dealer's hidden card is a 10, jack, queen or king any insurance wager pays out at a pre-determined ratio, generally 2:1, and all other wagers lose. Generally if a player “buys insurance” and the dealer's hidden card is a 10, jack, queen, or king, the player should break even overall on the hand.

According to yet another embodiment of the invention, an apparatus for playing a simulated card game comprises a display, a computer processor in communication with the display, the processor having a data structure storing data capable of representing a deck of playing cards and data representing a predetermined payment schedule, each deck comprising four suits of cards, including spot cards from ace to ten, jacks, queens and kings, each of the spot cards from ace to 9 having a value equal to the number of the corresponding spot card with ace being one and each of the tens, jacks, queens and kings having a value of zero, a total count of any hand being a the last digit of the, sum of the value of the cards in the hand. The processor also has means for randomly selecting playing card data from the data structure. There are means for accepting wagers from at least one player in communication with the processor. The processor is configured to, upon prompting of play, select and display first and second cards for each player and at least a first card for a two-card dealer hand. The processor is configured to offer each player the option to make an insurance wager if the first card from the two card dealer hand is either an 8 or a 9, then payout the insurance wager, and cause all other wagers to lose if the dealer's second card is a jack, queen, or king. There are means for each player to input a command to the processor either to stand with his initial two card hand or to be dealt a third card the value of which is added by the processor to the value of his initial hand to determine the total count of the player's hand. The processor requires the respective player to increase his initial wager by a predetermined amount before displaying the third card. If only the first card of the dealer hand is displayed prior to displaying each player's final hand, the processor is configured to display a second card for the two card dealer hand after all players' hands are completed. The processor is further configured to compare the total count of the two card dealer hand with the total count of each player's hand to determine whether or not each player's hand is a winning or tie hand by having a total count exceeding the total count of the two card dealer hand by at least a predetermined number of points equal to or in excess of one point, to issue to each player having a winning hand a payment according to said payment schedule which provides for said payment being at least 1 to 1 and for larger payments if the winning hand has a total count exceeding the total count of the dealer hand by one or more specified number of points greater than said predetermined number, and to collect the wager of each player having a losing hand, which is a hand having a total point count equal to or less than the two card dealer hand and not exceeding said two card dealer hand by at least said predetermined number.

These and other aspects of the disclosed methods and apparatus for playing card games will become more readily apparent to those having ordinary skill in the gaming art from the following detailed description taken in conjunction with the accompanying drawings.

### BRIEF DESCRIPTION OF THE DRAWINGS

So that those having ordinary skill in the art to which the present disclosure pertains more readily understand how to make and use the subject invention, exemplary embodiments of methods and apparatus for playing card games or simulated card games will be described in detail herein below with reference to the drawings, wherein:

FIG. 1 is a plan view of a table layout that can be used in playing card games according to the methods described in the present disclosure;

FIG. 2 is a table showing four alternative payout schedules for card games played according to the methods described herein, each of these payout schedules having a different casino advantage;

FIG. 3 is a two column table showing the results of a player's bet for each possible total count of a dealer's hand;

FIG. 4 is a two column table showing when a player may buy insurance;

FIG. 5 is a display and logic diagram for an apparatus for playing a simulated card game according to the present disclosure.

### DETAILED DESCRIPTION OF EXEMPLARY EMBODIMENTS

Advantageous methods of playing card games that involve a dealer and at least one player are disclosed herein. These card games, which include some aspects of both the game of blackjack or “21” and the game of Baccarat, can be fun to play for both skilled players and unskilled players and they can be suitable for use in casinos and other gaming establishments. The particularly disclosed methods of playing these games are merely illustrative of such playing methods that can be played according to the present disclosure.

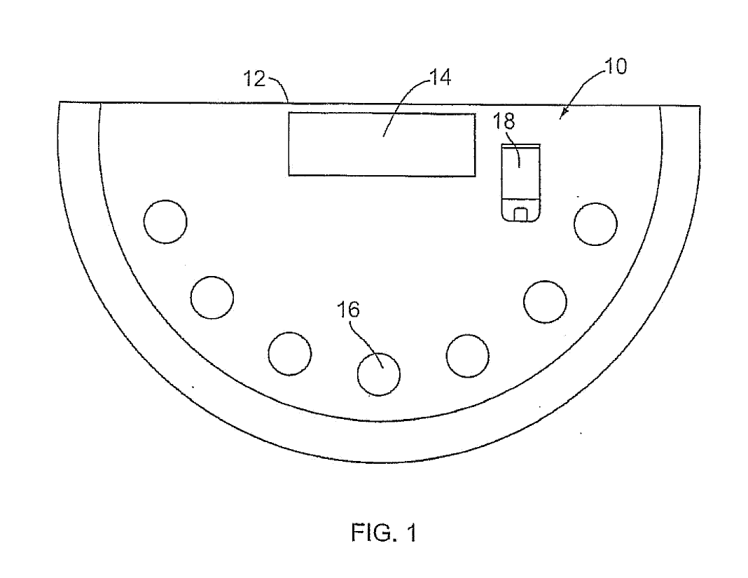

FIG. 1 illustrates a table layout or format that can be used in conjunction with the present methods of playing a card game, this layout being similar to or the same as that used in the well-known game of blackjack. The illustrated table layout is suitable for use by a dealer and by one to seven players. The table layout 10 can have a generally semi-circular shape which is typical for a gaming table used at casinos and similar facilities. A human dealer employed by the casino normally stands at the center of straight side 12 of the layout. The dealer (who can also be called a banker) is responsible for playing chips, which represent “the Bank” at the table, and these chips, which can be standard chips, are generally kept in area 14 within easy reach of the dealer. The chips in area 14 are used to pay out winnings to the various players of the card game. A plurality of playing areas 16 are arranged around the bank area in a generally semi-circular pattern and, in the illustrated table layout there are seven of these playing areas but it will be appreciated that there could be more or fewer of these areas. Although the areas 16 are shown as having a circular shape, other shapes are also possible, including squares or rectangles. Each player is generally required to place his wagers in the area 16 assigned to him. Normally a shoe 18 is provided on one side of the table close to the dealer and the use and construction of the shoe is well known in the gaming industry. The shoe houses the cards to be dealt and it can hold from one to eight standard decks of cards. The shoe allows cards to be drawn one at a time from the front of the stack of cards. In the card games described herein, it is also possible to deal a card to the players and to the dealer without the use of a shoe. Prior to the start of a card game, the deck or decks are shuffled either manually by the dealer or by means of a shuffling machine. If the shoe contains more than one deck, after many rounds of play and an end marking card is taken out of the shoe, all of the cards are shuffled and reused or discarded and replaced by new cards. The gaming house generally sets minimum and maximum limits for the bets or wagers and these limits are generally posted at the table. The amount of any initial wager by a player can vary within the set limits.

According to one embodiment of the present playing method, after each player makes an initial wager within the aforementioned limits against the gaming house conducting the card game, the dealer deals first and second cards to each player and himself from the shuffled stack of playing cards that includes at least one full deck (not including any joker cards). The present card games can be played with standard playing cards with each deck comprising four suites of cards including spot cards with numbers from ace to ten, jacks, queens and kings. For purposes of the present specification, an ace shall be considered a spot card with the number 1 and with a value of one. For purposes of the present games, the cards are assigned a value according to the usual rules for standard Baccarat. In other words, each of the spot cards from ace to 9 have a value equal to the number of the corresponding spot card and each of the tens, jacks, queens and kings have a value of zero. A total count for any hand in these games is the sum of the value of the cards in the hand except that a sum of two digits has a total count equal to the last digit. When the dealer deals the players at his table, the standard dealing procedure is that a single card is dealt to each player, starting with the player on the dealer's left and a single card is dealt to the dealer and these cards are dealt face-up. This process is repeated so that each player and the dealer have two cards with the second card to the dealer being facedown and called the hole card, a card that is normally placed under the first face-up card. The dealer can deal the second card to the player either face-up or facedown although in an exemplary version of the game, the second card is dealt face-up. The suite of any particular card dealt to a player or to the dealer has no significance in the game.

According to yet another embodiment of the present playing method, if the dealer's face-up card is an 8 or 9 the player is offered the option to make an insurance wager.

After the initial two cards have been dealt to each player and to the dealer, each player (or the single player if only one person is playing) is allowed a first option, namely to stand with his initial two card hand, in which case no further cards are dealt to the player. Also, each player has a second option which is to be dealt a third card, the value of which is added to the value of his initial hand to determine the total count of the player's hand. However, in the event that any player selects this second option, the player is required to increase his initial wager by a predetermined amount, which, in an exemplary version of a card game according to the invention is an amount equal to his initial wager before receiving the third card. In other words, the player is required to double his initial wager. For another wager, which redoubles the player's wager, the player has the option of drawing a fourth card.

At least two additional options can be given to each player at this stage in the play of the game. The first of these is the option to split the player's two cards if these cards are equal in value so that the player in effect has first and second hands. In this case, the player receives from the dealer at least a second card for each of these two hands. In order to make this split election, the electing player is required to place a wager equal to his initial wager on the additional or second hand. It will be appreciated by those familiar with the game of blackjack that this option is similar to an option available in the game of blackjack. Each of the two hands can then be played by the player in the same manner as a single hand with the same options being available to the player for each hand. Each player can be allowed to split his hand up to three times in an exemplary version of the present game but the particular rules of the gaming house may allow only one or two splits.

Another significant option available to each player after he or she has received her initial two cards is a so-called “surrender” option. According to this option, each player is offered the opportunity to surrender a portion of his initial wager and then to receive back a remaining portion of his initial wager and withdraw from further play of the game.

According to an exemplary form of this option, each player, after seeing his two cards and the dealer's face-up card, forfeits half the original wager made on the original two-card hand. Although the game rules may provide for the forfeiting of a different percentage of the original wager, a forfeit of one half the original wager is considered easy to carry out both from the standpoint of the dealer and the player since the amount to be forfeited is relatively easy to calculate and the appropriate chips to carry out the forfeiting process are normally available to a player or to the dealer.

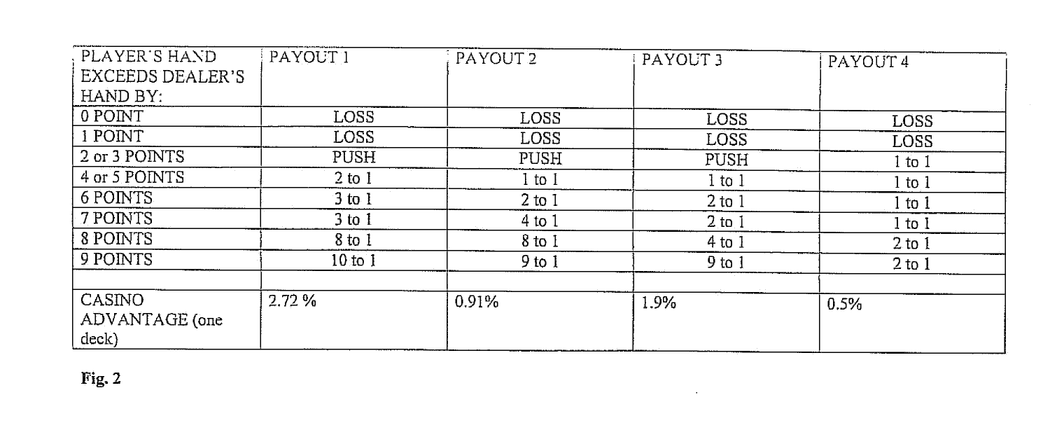

Assuming the second card dealt to the dealer was dealt face down, this second or hole card is kept facedown until each player has completed his hand or hands and until the final count of each hand of each player has been determined. Then the second card of the dealer can be turned up and the total count of the dealer's two-card hand determined. The dealer is then normally required to state the total value of his hand. Note that according to versions of the present methods of playing a card game, the dealer is not entitled to receive or be dealt any card beyond his first and second cards. The next step in the game is to compare the total count of the dealer's two card hand with the total count of each player's hand. According to an exemplary embodiment of the present playing method, any player's hand having a total count at least two points higher than the total count of the dealer's hand results in a push (tie) or win for the respective player and any player's hand having a total count which does not exceed the total count of the dealer's hand by more than one point is a loss for the respective player. According to another version of the playing method, a player's hand is a winning or tie hand if the total count of his hand exceeds the total count of the dealer's hand by a predetermined number of points equal to or in excess of one point. Any player completing the round with a winning hand receives a payment from the dealer according to a predetermined payout schedule. Four possible and alternative payout schedules for an exemplary form of the present game are shown in the Table of FIG. 2 which gives a summary of one dollar bet settlements for the four payout scenarios. The advantage to the casino under each scenario is indicated at the bottom of the Table, these percentages being based on one deck of cards being used. These percentages further assume that no additional cards are drawn by the players beyond the first two cards. The casino advantage may vary with the use of multiple decks and with the application of different options for playing the game. It will be seen that the casino advantage can range from a small amount of 0.5% according to payout scenario 2 to a relatively large advantage of 2.72% under payout scenario 1.

With further reference to the Table of FIG. 2, if the player's hand exceeds the dealer's hand by two or three points, the result is a push or tie for the player under the first two scenarios and a payout of 1 to 1 under scenario 3. If the player's hand exceeds the dealer's hand by four or five points, the payout to the player is 1 to 1 under any of the scenarios. If the player's hand exceeds the dealer's hand by six points, the payout is two to one under each of the four scenarios. If the player's hand exceeds the dealer's hand by seven points, the payout is 3 to 1 under scenario 1, 4 to 1 under scenario 2, and 2 to 1 under scenario 3. If the player's hand exceeds the dealer's hand by eight points, the payout is 8 to 1 under scenarios 1 and 2 and 4 to 1 under scenario 3. Finally, if the player's hand exceeds the dealer's hand by the maximum amount possible, namely nine points, the payout is ten to 1 under scenario 1 and 9 to 1 under scenarios 2 and 3. Once all of the bets or wagers are resolved, the dealer collects all the cards, new wagers are made and a new round of play begins.

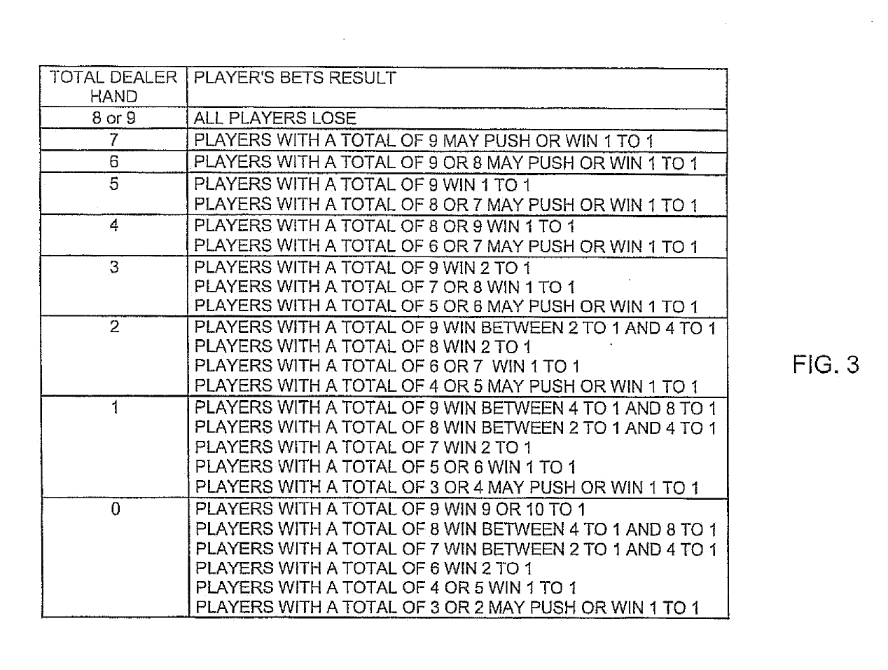

The Table of FIG. 3 is provided to illustrate each of the possible hand results and whether a particular hand result results in a player or players losing, results in a tie or a push, or results in a win with a particular payout ratio. This Table provides only an example of the possible results of the player's hand and payouts. All possible totals for the dealer's hand are listed in the left hand column. In the case of a high count of 8 or 9 in the dealer's hand, all of the players who have made a wager will lose. On the other hand, if the dealer's hand is a count of only zero, the only players that will lose will be players with a total hand count of zero or 1.

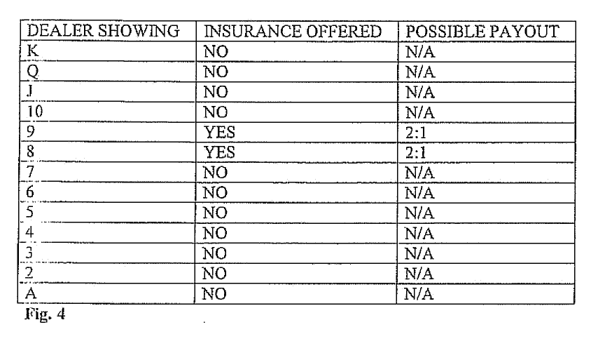

FIG. 4 illustrates when a player will have the option of buying insurance. If the dealer is showing an 8 or 9 on top, the player may place an insurance bet for a predetermined amount. If the dealer's hidden card is a 10, jack, queen, or king the insurance wager pays out at a pre-determined ratio, and all other wagers automatically lose. A possible payout ratio for an insurance bet is detailed in FIG. 4.

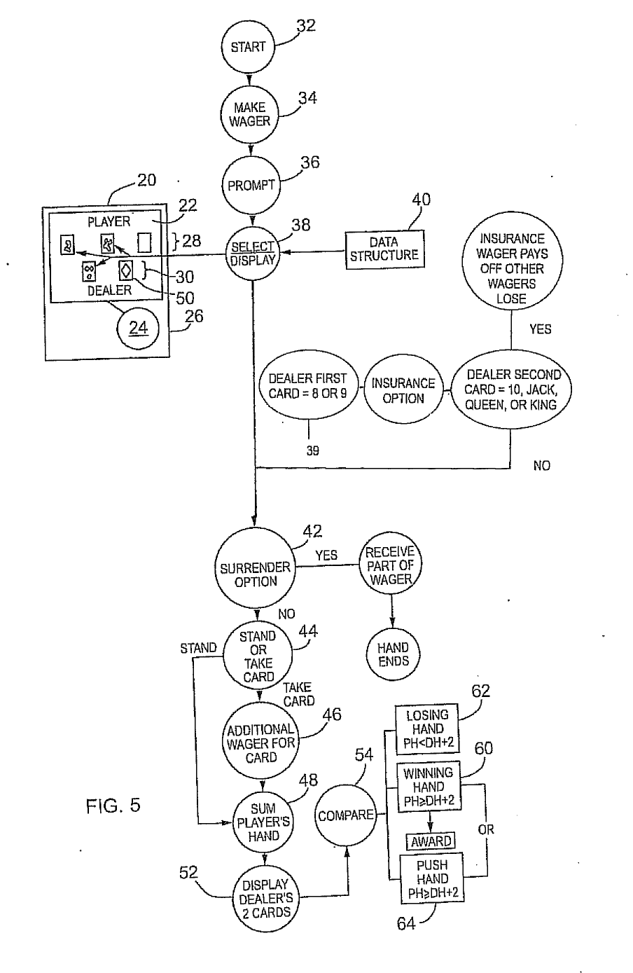

FIG. 5 illustrates an apparatus for playing one or more of the simulated card games similar to the methods for card games played with actual cards described above. Although this diagramically illustrated apparatus will be described only with respect to its use to play a game similar to one of the exemplary card games described above, it will be understood by those skilled in the art that a simulated card game similar to any of the above described card games could be played on an apparatus similar to the apparatus 20 configured by appropriate software. The apparatus 20 includes a display 22 to present or display the cards to a player during play of the game. It will be understood that the display can either be an electronic display or can be a mechanical display where simulated playing cards are displayed through transparent windows and can, for example, be printed or otherwise displayed on reels similar to those commonly found in slot machines. The construction of both electronic displays and mechanical displays is well known in the gaming art and accordingly a detail description herein is deemed unnecessary. The display 22 and the play of the game itself is controlled by a processor 24 which can be mounted in and enclosed by a housing 26 of the apparatus. As illustrated, the display can have a designated area 28 for the display of the player hand and another area 30 for the display of a two-card dealer hand.

The play of the game can begin at start 32, which can take the form of a starter ON button and, upon activation of the start, the display is energized and the processor 24 is ready to control the play of the game. The processor has a data structure storing data capable of representing a deck of playing cards as well as data representing a predetermined payout schedule. The stored data can also represent or include predetermined rules for the card game. Each deck of simulated cards in the stored data comprises four suites of cards, including spot cards with numbers from 1 (or ace) to 10, jacks, queens and kings. Again, in determining the point total of the player hand or the dealer hand, each of the spot cards that have been selected and displayed from ace to 9 have a value equal to the number of the corresponding spot card and each of the tens, jacks, queens and kings have a value of zero. The processor calculates the total count of any hand as the sum of the value of the cards in the displayed hand except that a sum of two digits has a total count equal to the last digit.

At step 34, each player inputs his desired wager to play a hand. In the event that there are two or more players in the game, it will be understood that there can be an equal number of the apparatus 20, one for each player and these apparatus can be electronically connected to coordinate the play of the game. As well known in the gaming art, a wager can be input by a player wagering gaming credits accumulated at the apparatus 20, by inserting coins or tokens, or by inserting cash or script at a cash reader to accumulate game credits or the like. When the desired wager has been made at 34, this information is input into the processor and recorded.

The processor includes a random number generator, a well-known device in the gaming art. The processor 24, having been prompted at 36 by the input of one or more wagers, then proceeds to step 38 by randomly selecting and controlling the display 22 so as to select and display first and second cards for each player and at least a first card for a two card dealer hand. Depending on the particular rules for the game as stored in the apparatus, a second card for the dealer can also be displayed at this time or a simulated second card can be shown but in a face down position (only to be revealed later during the play of the hand). The data structure for storing data for use by the processor is indicated in FIG. 5 at 40. Again, it will be understood that this component can be housed within the housing 26 as well.

If the rules for the simulated card game being played on apparatus 20 include a means to offer each player the opportunity to for an insurance option, the option can be provided by program 39 which determines if the dealer's first card is either an “8” or “9”, if it is processor 24 is configured to allow the user to make an insurance wager, then the processor 24 determines if the dealer's second card is a 10, jack, queen, or king, paying out on the insurance wagers and causing all other wagers to lose if the second card is a 10, jack, queen, or king.

If the rules for the simulated card game being played on the apparatus 20 include provision for a surrender option, this option can be provided in the program at 42. With this option, the processor 24 is configured to allow each player input a command or alternate command to the processor (for example, by means of a dedicated push button on the apparatus) after the first and second cards are displayed to the respective player. By selecting the surrender option, the player is thereby agreeing to surrender or give up a portion of his wager in return for receiving back from the apparatus 20 a remaining portion of his wager. With this elected option, the processor is configured to terminate further play of the hand of each play inputting the surrender command.

Assuming that the player either does not have the surrender option or does not exercise the surrender option, the processor then provides each player the choice of either standing with his initial two card hand or the choice of being dealt a third card, the value of which is added to the value of his initial hand to determine the total count of the player's hand. A mechanism for or a means for each player to input his choice is provided at 44. This mechanism can, for example, be a dedicated push button mounted on the apparatus 20 and which may or may not light up at this stage of the game when the player is required to decide whether or not to stand or take an additional third card. Other types of devices can also be provided for use by the player to signal the processor to draw a third card or stand. Alternative input means can include a keyboard or a mouse or even a mechanical lever such as that found on slot machines. If a player elects to receive a third card at 44, the processor randomly selects from the data structure 40 an additional, third card for the player's hand. However, before selecting and/or displaying the third card, the processor 24 requires the respective player to increase his initial wager by a predetermined amount which, in an exemplary version, is equal to the initial wager by that player. This additional wagering step is indicated at 46. After the initial required wager has been made, the processor sums the third card with the first two cards at step 48, in accordance with the aforementioned counting rules. In an exemplary version of the apparatus, the final hand count for the player is displayed on the display 22.

Then, if only the first card of the dealer hand has been displayed after the initial selecting and displaying steps and prior to displaying the final hand for each player, the processor is configured to display a second card for the two card dealer hand and the sum total of the two card dealer hand is calculated and, in an exemplary embodiment, displayed on the display 22. The display of the dealer's two-card hand is indicated at step 52. Then, at step 54, the processor 24 compares the total count of the two-card dealer hand with the total count of each player hand, the processor being configured to make this comparison. The processor thus determines whether or not each player's hand is a winning or tie hand by having a total count exceeding the total count of the two card dealer hand by at least a predetermined number of points which is equal to or in excess of one point, this predetermined number in an exemplary version of the processor being two points. If the processor determines that the player hand is a winning hand, it will issue to the winning player a payment or award according to the predetermined payment schedule. This winning hand outcome is indicated at 60. If, at 62, the player hand has a total point count equal to or less than the dealer hand and the total count of the player hand does not exceed the dealer hand by at least the predetermined number, the house is the winner and the processor causes the apparatus to collect the wager of the losing player. The possibility of a push hand is indicated at 64. In the case of the push result, the total wager of the player is returned by the apparatus 20 to the player.

As indicated, the apparatus 20 can be adapted to include a plurality of players playing at individual terminals against a common, displayed dealer hand. Also, it will be appreciated by those skilled in the gaming art that the apparatus 50 may be a personal computer terminal communicating through the internet with a remote host for play of the simulated card game by one or more players at their remote terminals.

While the present invention has been illustrated and described as embodied in various exemplary embodiments or methods, it should be understood that the present invention is not limited to the particular methods of play described herein since it will be understood that various omissions, modifications, substitutions and changes in the disclosed methods may be made by those skilled in the art without departing in any way from the spirit and scope of the present invention. For example, those of ordinary skill in the gaming art will readily adapt the present disclosure for various other gaming applications without departing from the spirit and scope of the present invention.

1. A method of playing a card game involving a dealer and at least one player, said game comprising the steps of:
having each player make an initial wager against a gaming house conducting the card game;
dealing first and second cards to each player and to the dealer from at least one deck of playing cards, each deck comprising four suites of cards, including spot cards with numbers from one to ten, jacks, queens and kings, each of the spot cards from ace to 9 having a value equal to the number of the corresponding spot card and each of the tens, jacks, queens and kings having a value of zero, a total count of any hand being a sum of the value of the cards in the hand except that a sum of two digits has a total count equal to the last digit;
allowing each player a first option to stand with the initial two card hand and a second option to be dealt a third card the value of which is added to the value of the initial hand to determine the total count of the player's hand;
in the event any player selects said second option, requiring the player to double the initial wager before receiving the third card;
then comparing the total count of the dealer's two card hand with the total count of each player's hand, wherein any player's hand having a total count that is at least pre-determined amount of points higher than the total count of the dealer's hand results in a push or win for the respective player and any player's hand having a total count which does not exceed the total count of the dealer's hand by more than said pre-determined amount is a loss for the respective player; and
making a payment to each winning player according to a predetermined payout schedule.

2. A method of playing a card game according to claim 1 including offering each player a third option, after said first and second cards are dealt to each player and to the dealer, to surrender a portion of the initial wager and then to receive back a remaining portion of the initial wager and withdraw from further play of the hand.

3. A method of playing a card game according to claim 1 wherein, in the event that the first and second cards dealt to any player are cards of equal value, the player or players with the equal value cards are provided an option to elect to split the two cards into a first and a second hand and to receive at least a second card for each of these two hands, said election to split requiring the electing player to place a wager equal to the initial wager on the second hand.

4. A method of playing a card game according to claim 1 wherein the second card dealt to the dealer is kept face-down until each player has completed the hand and determined the final count of the player's hand.

5. A method of playing a card game according to claim 4 wherein if the dealer's first card is an 8 or 9, and the dealer's second card is a 10, jack, queen or king, each player loses.

6. A method of playing a card game according to claim 5 wherein if the dealer's first card is an 8 or 9, each player is offered the chance to make an insurance wager, if the dealer's second card is a 10, jack, queen or king said insurance wager pays out at a predetermined ratio.

7. A method of playing a card game according to claim 1 including providing each player a further option of being dealt a fourth card, the value of which is added to the value of the three cards previously dealt to determine the total count of the player's hand before this total count is compared to the total count of the dealer's hand;
each player making this election must redouble the initial wager against the gaming house.

8. A method of playing a card game according to claim 1 wherein each player is only allowed to receive a third card if he or she is playing a single hand only and wherein if he or she is dealt the third card, the third card is dealt face down for each respective player to handle.

9. A method of playing a card game according to claim 7 wherein each player is only allowed to receive a third card if requested and is only allowed to receive a fourth card if requested if he or she is playing a single hand only, and wherein any third card and any fourth card is dealt face down for each respective player.

10. A method of playing a card game according to claim 1 wherein the player wins a pre-determined amount if the player's total count exceeds the dealer's total count by two points.

11. A method of playing a card game according to claim 1 wherein the player wins a pre-determined amount if the player's total count exceeds the dealer's total count by one point.

12. Apparatus for playing a simulated card game comprising:
a display;
a computer processor in communication with said display, said processor having a data structure storing data capable of representing a deck of playing cards and data representing a predetermined payment schedule, each deck comprising four suites of cards, including spot cards with numbers from ace to ten, jacks, queens and kings, each of the spot cards from ace to 9 having a value equal to the number of the corresponding spot card and each of the tens, jacks, queens and kings having a value of zero, a total count of any hand being a sum of the value of the cards in the hand except that a sum of two digits has a total count equal to the last digit, said processor also having means for randomly selecting playing card data from said data structure;
means for accepting wagers from at least one player in communication with said processor;
said processor configured to, upon prompting of play, select and display first and second cards for each player and at least a first card for a two card dealer hand;
means for each player to input a command to the processor either to stand with the initial two card hand or to be dealt a third card the value of which is added by the processor to the value of the initial hand to determine the total count of the player's hand, said processor requiring the respective player to increase the initial wager by a predetermined amount before displaying said third card;
if only the first card of the dealer hand is displayed prior to displaying each player's final hand, said processor is configured to display a second card for the two card dealer hand after the player's hand or all player's hands is or are finalized;
said processor further configured to compare the total count of the two card dealer hand with the total count of each player's hand, to determine whether or not each player's hand is a winning or tie hand by having a total count exceeding the total count of the two card dealer hand by at least a predetermined number of points which is equal to or in excess of one point, to issue to each player having a winning hand a payment according to said payment schedule which provides for a payment of at least 1 to 1 and for larger payments if the winning hand has a total count exceeding the total count of the dealer hand by one or more specified number of points greater than said predetermined number, and to collect the wager of each player having a losing hand which is a hand having a total point count equal to or less than the two card dealer hand and not exceeding said two card dealer hand by at least said predetermined number.

13. The apparatus of claim 12 wherein, before displaying said third card, said processor requires the requesting player to increase the initial wager by an amount equal to the initial wager.

14. The apparatus of claim 13 wherein said predetermined number of points for a player to have a winning or push hand is 2.

15. The apparatus of claim 12 wherein said processor is further configured to allow each player to input an alternative command to the processor, after said first and second cards are displayed to each player, to surrender a portion of the wager in order to receive back a remaining portion of the wager and is configured to terminate further play of the hand of each player inputting said alternative command.

16. The apparatus of claim 13 wherein said processor is configured to select and display said second card of the dealer hand only after the final hand for each player has been displayed.

17. The apparatus of claim 15 wherein said processor is configured to cause each player hand to lose if the dealer's first card is an 8 or 9, and the dealer's second card is a 10, jack, queen or king.

18. The apparatus of claim 17 wherein said process is configured to allow each player to make an insurance wager if the dealer's first card is an 8 or 9, if the dealer's second card is a 10, jack, queen, or king the insurance wager pays out at a pre-determined ratio.

19. Apparatus for playing a simulated card game comprising:
a display;
a computer processor in communication with said display, said processor having a data structure storing data capable of representing a deck of playing cards, data representing a predetermined payout schedule and data representing predetermined rules for the card game, each deck comprising four suits of cards, including spot cards from ace to ten, jacks, queens and kings, each of the spot cards from ace to 9 having a value equal to the number of the corresponding spot card with ace being 1 and each of the tens, jacks, queens and kings having a value of zero, a total count of any hand being a sum of the value of the cards in the hand except that a sum of two digits has a total count equal to the last digit, said processor also having means for randomly selecting playing card data from said data structure;
said processor also having means for randomly selecting playing card data from said data structure;
means for accepting wagers from at least one player in communication with said processor;
said processor configured to, upon prompting of play, select and display first and second cards for a single player hand and for a two card dealer hand;
if allowed under said predetermined rules, said processor being configured to select and display one or more additional cards for the player hand and for the dealer hand according to said predetermined rules for the card game and to determine a total count for each hand after all permitted additional cards have been displayed;
said processor being configured to compare the total count of the dealer hand with the total count of the player hand, wherein if the player hand has a total count at least 2 points higher than the total count of the dealer hand, the result for each wagering player is either a push or a win and if the player hand has a total count which does not exceed the total count of the dealer's hand by more than 1 point, the result for each such wagering player is a losing hand, to issue to each player a payment according to said payment schedule if the player hand is a winning hand, and to collect each player's wager if the player hand is a losing hand.

20. The apparatus of claim 19 wherein said processor is configured to select and display only two cards for the dealer hand and only two cards for the player hand during a complete round of the game.
